(19) United States
(12) Patent Application Publication
(10) Pub. No.: US 2020/0201518 A1
(43) Pub. Date: Jun. 25, 2020

(54) METHOD FOR STARTING APPLICATION AND ELECTRONIC DEVICE FOR IMPLEMENTING SAME

(71) Applicant: Samsung Electronics Co., Ltd., Gyeonggi-do (KR)

(72) Inventors: Kwanjin JUNG, Seoul (KR); Hyunchul SEOK, Gyeonggi-do (KR)

(21) Appl. No.: 16/642,726

(22) PCT Filed: Jul. 9, 2018
(86) PCT No.: PCT/KR2018/007748

§ 371 Date: Feb. 27, 2020

(30) Foreign Application Priority Data
Sep. 1, 2017 (KR) 10-2017-0111839

(51) Int. Cl. G06F 3/0484; G06F 3/0481; G06F 3/041; G06F 9/445

(52) U.S. Cl. CPC G06F 3/04842; G06F 9/445; G06F 3/0412; G06F 3/0481

(57) ABSTRACT

An electronic device according to various embodiments of the present invention comprises: a touch-sensitive display; a processor electrically coupled to the display; and a memory electrically coupled to the processor, wherein the memory may store instructions that when executed, cause the processor to: display an icon on the display; receive a touch down event for the icon via the display; configure a screen to be displayed on the display, in response to the touch down event; receive a touch-up event for the icon via the display; and display the configured screen on the display, in response to the touch-up event. Other various embodiments are also possible.

### TECHNICAL FIELD

Various embodiments of the disclosure relate to a method and device for a quick launch of an application.

### BACKGROUND ART

An electronic device may include a touch-sensitive display and display an icon corresponding to an application through the display. In response to a user's touch gesture on the icon, the electronic device may provide a function or service of the application.

### DISCLOSURE OF INVENTION

### Technical Problem

The electronic device may provide a screen related to the application through the display. An operation for providing such a screen may be started, for example, in response to a release (i.e., a touch-up) of a touch (i.e., a touch-down) on the icon. That is, the above operation is started at the time of the touch-up.

Various embodiments of the disclosure may allow the above operation to be started at the time of a touch-down, thereby quickly responding to a user input. In addition, various embodiments of the disclosure may provide an efficient memory management method and device for a quick launch of an application.

SOLUTION TO TECHNICAL

According to various embodiments of the disclosure, an electronic device may include a touch-sensitive display; a processor electrically coupled to the display; and a memory electrically coupled to the processor, wherein the memory may store instructions that cause, when executed, the processor to: display an icon on the display, receive a touch-down event for the icon through the display, configure a screen to be displayed on the display, in response to the touch-down event, receive a touch-up event for the icon through the display, and display the configured screen on the display, in response to the touch-up event.

According to various embodiments of the disclosure, a method for operating an electronic device may include displaying an icon on a touch-sensitive display; receiving a touch-down event for the icon through the touch-sensitive display; executing a first process corresponding to the icon, in response to the touch-down event; receiving a touch-up event for the icon through the display; and adding an activity of the application to the first process, in response to the touch-up event.

### ADVANTAGEOUS EFFECTS OF INVENTION

According to various embodiments of the disclosure, the electronic device may launch an application quickly in response to a user input.

### [BRIEF DESCRIPTION OF DRAWINGS ]

FIG. 1 is a block diagram illustrating an electronic device in a network environment according to various embodiments.

FIG. 2 is a block diagram illustrating a program according to various embodiments.

FIG. 3 is a diagram illustrating operations of a program according to various embodiments.

FIG. 4 is a diagram illustrating operations of a program according to various embodiments.

FIG. 5 is a flow diagram illustrating operations of a processor according to various embodiments.

FIG. 6 is a flow diagram illustrating operations of a processor according to various embodiments.

FIG. 7 is a flow diagram illustrating operations of a process management module according to various embodiments.

FIG. 8 is a flow diagram illustrating operations of a process management module according to various embodiments.

FIGS. 9A to 9E are diagrams illustrating operations of managing a memory in an electronic device according to various embodiments.

### MODE FOR THE INVENTION

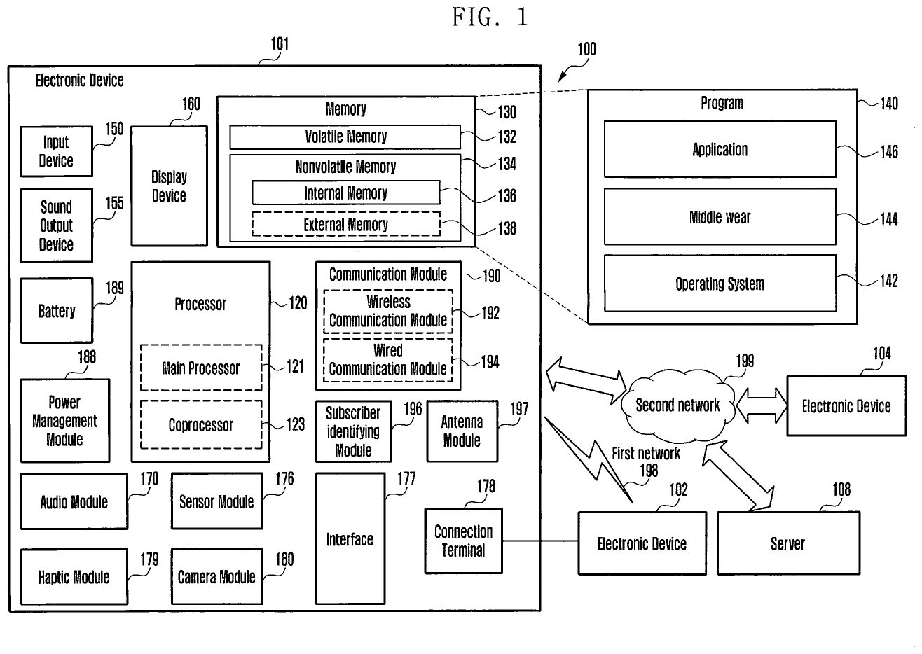

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module(SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, .a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BluetoothTM, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other.

According to an embodiment, the wireless communication module 192 may identify and authenticate the electronic device 101 in a communication network, using subscriber information stored in the subscriber identification module 196.

The antenna module 197 may include at least one antenna for transmitting or receiving a signal or power to or from the outside. According to an embodiment, the communication module 190 (e.g., the wireless communication module 192) may transmit a signal to or receive a signal from an external electronic device through an antenna suitable for a communication scheme.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

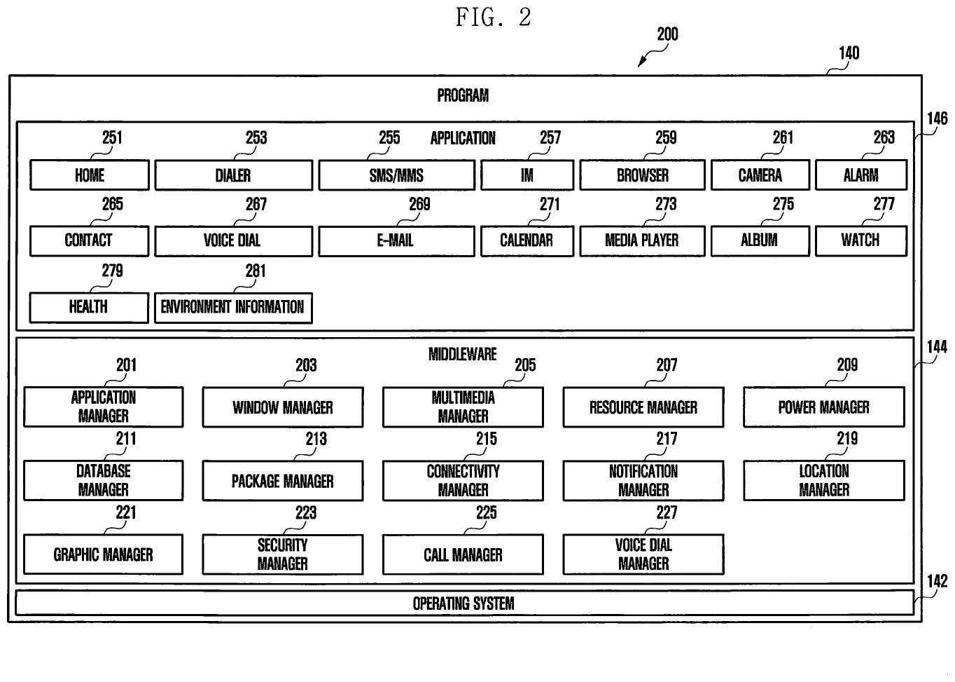

FIG. 2 is a block diagram 200 illustrating the program 140 according to various embodiments. According to an embodiment, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input device 150, the sound output device 155, the display device 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227. The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130.The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects. The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101. The device management application may control the power (e.g., turn-on or turn-off) or the function (e.g., adjustment of brightness, resolution, or focus) of the external electronic device or some component thereof (e.g., a display device or a camera module of the external electronic device). The device management application, additionally or alternatively, may support installation, delete, or update of an application miming on the external electronic device.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor(e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

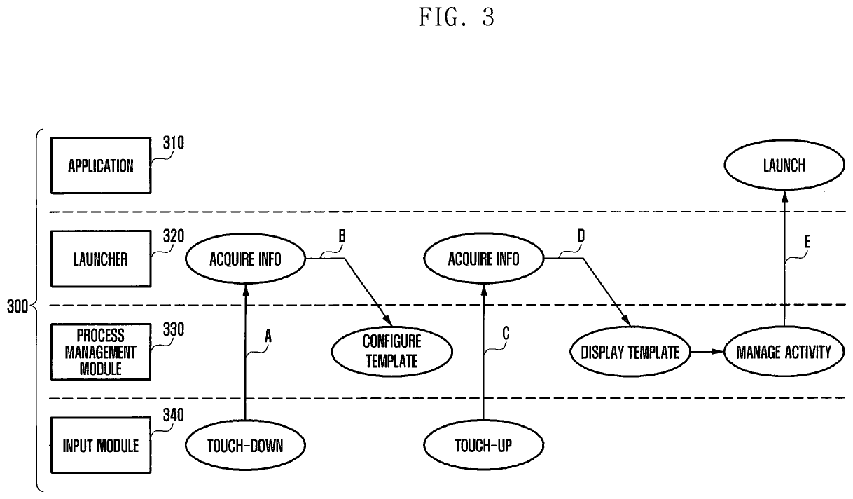

FIG. 3 is a diagram illustrating operations of a program 300 according to various embodiments. Referring to FIG. 3, the program 300 (e.g., the program 140 in FIG. 1) may be loaded into a volatile memory (e.g., the volatile memory 132 in FIG. 1) and executed by a processor (e.g., the processor 120 in FIG. 1). Thus, operations of the program 300 may be understood as being performed by the processor.

According to various embodiments, the program 300 may include an application 310, a launcher 320, a process management module 330, and an input module 340. The application 310 is executed by the process management module 330 and may be, for example, one of components of the application 146 shown in FIG. 2. The launcher 320 may be an application that controls the operation of the process management module 330 in response to an event received from the input module 340. The process management module 330 may include, for example, at least one of the window manager 203 or the application manager 201 shown in FIG. 2. Also, the process management module 330 may be, for example, a component included in the middleware 144 in FIG. 2, and may control the execution of a process corresponding to information received from the launcher 320. The input module 340 may be, for example, a component included in the middleware 144 in FIG. 2, and may transmit a user input to the launcher 320. The input module 340 may be, for example, a component included at least partially in the operating system 142 in FIG. 2.

According to various embodiments, the input module 340 may recognize the occurrence of a touch-down event through a touch-sensitive display (e.g., the display device 160 in FIG. 1 having a touch circuit). For example, a plurality of icons may be displayed on a screen of the display. The icon may correspond to a specific application, for example, the application 310. The touch-down event may refer to a state in which one icon is touched by a conductive object (e.g., a finger or a pen). The input module 340 may transmit (A) the touch-down event to the launcher 320. When the touch-down event is received, the launcher 320 may acquire information (e.g., an application name) about the touched icon from another component (e.g., the package manager 213). The launcher 320 may transmit (B) a first intent (e.g., including a value indicating ‘touch-down’ and the application name) to the process management module 330, based on the acquired information. According to an embodiment, the scheme of transmission (B) may be a broadcast scheme. An intent is what is transmitted or received between modules and may also be referred to as a signal, data, or a message.

According to various embodiments, the process management module 330 may configure a template in response to receiving the first intent from the launcher 320. For example, the process management module 330 may call and execute a process or activity for template configuration from a storage medium (e.g., the nonvolatile memory 134). According to an embodiment, the template may be a screen (e.g., a window frame or a graphic effect) displayed in front of a screen of the application 310 on the display.

According to various embodiments, the input module 340 may recognize the occurrence of a touch-up event through the display. The touch-up event may refer to a release of the touched state. The input module 340 may transmit (C) the touch-up event to the launcher 320. When the touch-up event is received, the launcher 320 may acquire information (e.g., an application name) about the touch-released icon from a package manager (e.g., the package manager 213). The launcher 320 may transmit (D) a second intent (e.g., including a value indicating ‘touch-up’ and the application name) to the process management module 330, based on the acquired information.

According to various embodiments, the process management module 330 may display the configured template on the display in response to receiving the second intent from the launcher 320. For example, the process management module 330 may call and execute a process or activity for displaying the template from a storage medium (e.g., the nonvolatile memory 134).

According to various embodiments, the process management module 330 may manage an activity of the launcher 320. For example, the process management module 330 may pause the activity of the launcher 320. For example, the pause may mean that the state of the launcher 320 is changed from the foreground to the background.

According to various embodiments, the process management module 330 may perform an operation of controlling (E) the launch of the application 310. For example, the operation of controlling (E) the launch of the application 310 may include an operation of controlling the display of the screen of the application 310. According to an embodiment, the process management module 330 may control the launch of the application 310 when the state of the launcher 320 is changed from the foreground to the background.

According to various embodiments, a template is configured when an icon is touched (e.g., template configuration is started at the time of a touch-down), the configured template is displayed when the touch is released, and then a screen of the corresponding application is displayed.

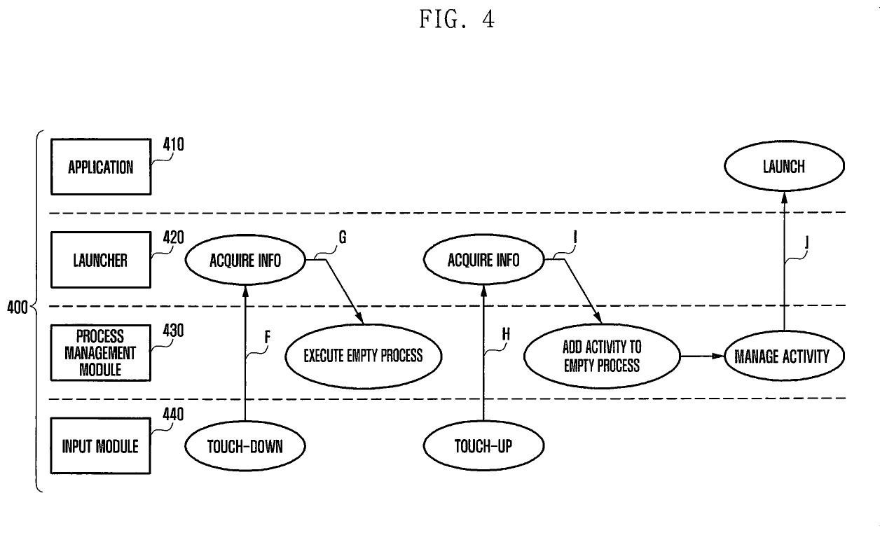

FIG. 4 is a diagram illustrating operations of a program 400 according to various embodiments. Referring to FIG. 4, the program 400 (e.g., the program 140 in FIG. 1) may be loaded into a volatile memory (e.g., the volatile memory 132 in FIG. 1) and executed by a processor (e.g., the processor 120 in FIG. 1). Thus, operations of the program 400 may be understood as being performed by the processor.

According to various embodiments, the program 400 may include an application 410, a launcher 420, a process management module 430, and an input module 440. According to an embodiment, the above components of the program 400 may perform the same operations as those of the corresponding components of the program 300 in FIG. 3.

According to various embodiments, the input module 440 may recognize the occurrence of a touch-down event through a touch-sensitive display (e.g., the display device 160 in FIG. 1 having a touch circuit). The touch-down event may refer to a state in which one icon is touched by a conductive object (e.g., a finger or a pen). The input module 340 may transmit (F) the touch-down event to the launcher 420. When the touch-down event is received, the launcher 420 may acquire information (e.g., an application name) about the touched icon from another component (e.g., the package manager 213). The launcher 420 may transmit (G) a first intent (e.g., including a value indicating ‘touch-down’ and the application name) to the process management module 430, based on the acquired information.

According to various embodiments, the process management module 430 may execute an empty process of the application 410 in response to receiving the first intent from the launcher 420. For example, processes may be classified into a foreground process, a visible process, a service process, a background process, and an empty process, depending on whether it has a component and depending on the state of the component. For example, the foreground process may be a process having a component that is in an active state to interact with a user. The visible process may be a process having a component that does not interact with a user but is visible through a screen. The service process may be a process having a component that does not interact with a user, is not visible through a screen, but is in service (e.g., audio playback, data download). The background process may be a process having a component that is in a stopped state. The empty process may be defined as a process that does not have any active component (e.g., activity, service, receiver, provider), unlike the other processes. In an embodiment, the empty process may be set to be the least important, that is, in case of insufficient memory, being deleted first from a memory prior to other processes.

According to various embodiments, the process management module 430 may perform an operation of managing a lifecycle of the empty process. For example, if a predetermined event (e.g., a touch-up event) does not occur within a given time (e.g., 1 second) after the empty process is executed, the empty process may be terminated (or deleted from the volatile memory). When the number of empty processes exceeds a predetermined value (e.g., two), the empty process loaded first into the memory may be terminated.

According to various embodiments, the input module 440 may recognize the occurrence of a touch-up event through the display. The input module 440 may transmit (H) the touch-up event to the launcher 420. When the touch-up event is received, the launcher 420 may acquire information (e.g., an application name) about the touch-released icon from a package manager (e.g., the package manager 213). The launcher 420 may transmit (I) a second intent (e.g., including a value indicating ‘touch-up’ and the application name) to the process management module 430, based on the acquired information.

According to various embodiments, the process management module 430 may add a component (e.g., an activity for implementing a graphic user interface (GUI)) to the empty process in response to receiving the second intent from the launcher 420.

According to various embodiments, the process management module 430 may manage an activity of the launcher 420. For example, the process management module 430 may pause the activity of the launcher 420.

According to various embodiments, the process management module 430 may perform an operation of controlling (J) the launch of the application 410. For example, the operation of controlling (J) the launch of the application 410 may include an operation of controlling the execution of the component added to the empty process. According to an embodiment, the process management module 430 may control the launch of the application 410 when the state of the launcher 420 is changed from the foreground to the background.

According to various embodiments, as the application 410 is launched, the process management module 430 may manage a state of a process. For example, when the application 410 is launched, the state of the empty process may be changed. For example, a flag value indicating the process state in corresponding application information may be changed from a value indicating an empty state to a value indicating the foreground.

According to various embodiments, although not shown, the process management module 430 may configure a template and execute the empty process in response to receiving the first intent. Also, the process management module 430 may display the template and add the component to the empty process in response to receiving the second intent.

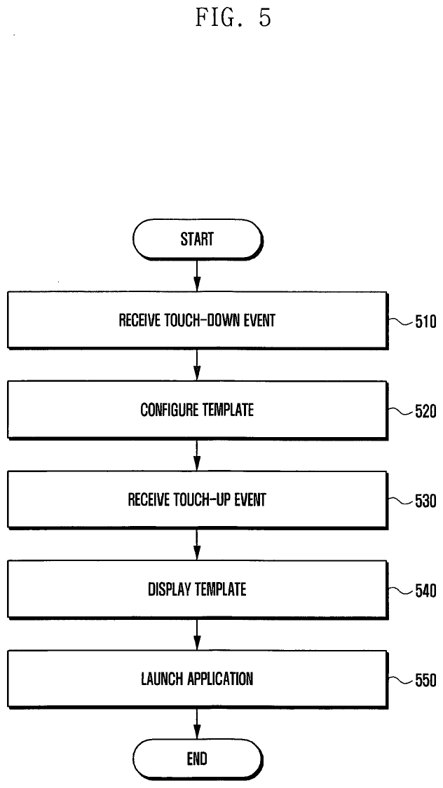

FIG. 5 is a flow diagram illustrating operations of a processor according to various embodiments.

Referring to FIG. 5, the following operations according to various embodiments may be performed through the electronic device 101, the processor 120, and the program (140 in FIG. 1, 300 in FIG. 3, or 400 in FIG. 4).

According to an embodiment, at operation 510, the processor may receive a touch-down event through a display device (e.g., 160 in FIG. 1). For example, the touch-down event may refer to a state in which an icon displayed on a screen is touched by a conductive object.

According to an embodiment, at operation 520, the processor may configure a template in response to the touch-down event.

According to an embodiment, at operation 530, the processor may receive a touch-up event through the display device. For example, the touch-up event may refer to a release of the touched state.

According to an embodiment, at operation 540, the processor may display the configured template through the display device in response to the touch-up event.

According to an embodiment, at operation 550, the processor may launch an application corresponding to the touched icon. For example, the processor may display a screen of the application, instead of the template, through the display device.

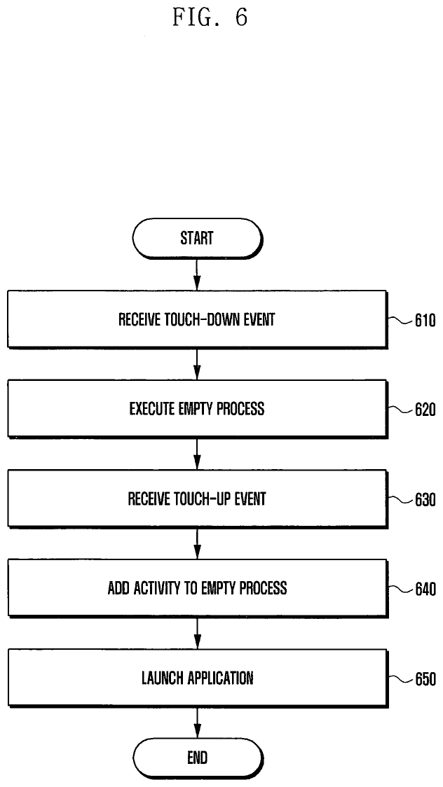

FIG. 6 is a flow diagram illustrating operations of a processor according to various embodiments.

Referring to FIG. 6, the following operations according to various embodiments may be performed through the electronic device 101, the processor 120, and the program (140 in FIG. 1, 300 in FIG. 3, or 400 in FIG. 4).

According to an embodiment, at operation 610, the processor may receive a touch-down event through a display device (e.g., 160 in FIG. 1). For example, the touch-down event may refer to a state in which an icon displayed on a screen is touched by a conductive object.

According to an embodiment, at operation 620, the processor may execute an empty process of an application corresponding to the touched icon in response to the touch-down event.

According to an embodiment, at operation 630, the processor may receive a touch-up event through the display device. For example, the touch-up event may refer to a release of the touched state.

According to an embodiment, at operation 640, the processor may add an activity to the empty process in response to the touch-up event. For example, the activity may include instructions set to display a graphic user interface (GUI) of an application for interacting with a user.

According to an embodiment, at operation 650, the processor may launch the application corresponding to the touched icon. For example, the processor may execute the added activity.

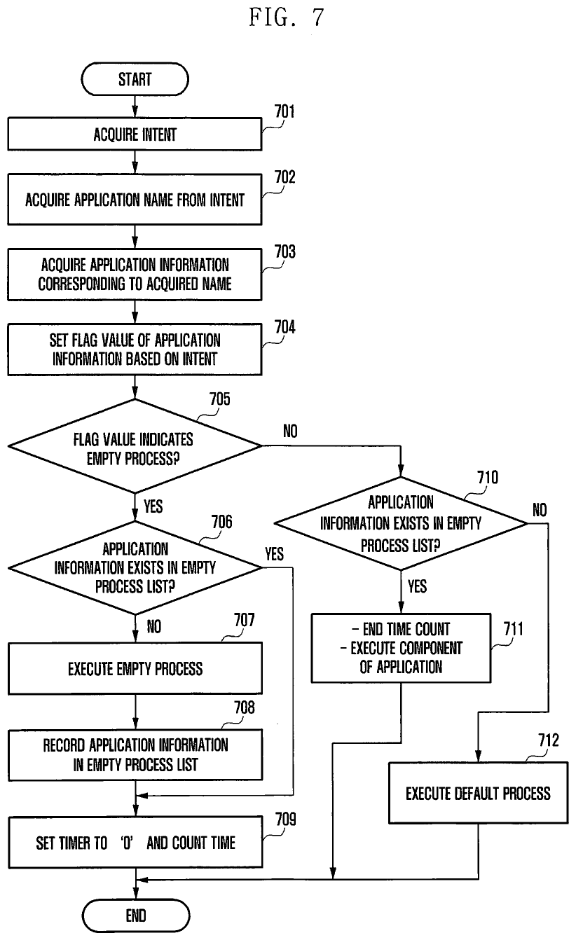

FIG. 7 is a flow diagram illustrating operations of a process management module according to various embodiments.

Referring to FIG. 7, the following operations according to various embodiments may be performed through the electronic device 101, the processor 120, and the program (140 in FIG. 1, 300 in FIG. 3, or 400 in FIG. 4).

According to an embodiment, at operation 701, the process management module (e.g., 330 in FIG. 3 or 430 in FIG. 4) may acquire a broadcasted intent. According to an embodiment, the intent is broadcast by a launcher (e.g., 320 in FIG. 3 or 420 in FIG. 4) and may include, for example, a value indicating a touch-down or a touch-up and an application name.

According to an embodiment, at operation 702, the process management module may acquire the application name from the intent.

According to an embodiment, at operation 703, the process management module may acquire application information corresponding to the acquired name from another component (e.g., the package manager 209 in FIG. 2).

According to an embodiment, at operation 704, the process management module may set a value of a flag contained in the application information, based on the intent. If the intent includes a value indicating a touch-down, the value of the flag may be set to a value indicating an empty process. If the intent includes a value indicating a touch-up, the value of the flag may be set to a value indicating a process (e.g., a foreground process) that has a component in an active state.

According to an embodiment, at operation 705, the process management module may determine whether the flag value is a value indicating an empty process.

According to an embodiment, when it is determined at the operation 705 that the flag value indicates the empty process, the process management module may determine at operation 706 whether the application information (e.g., a name) exists in an empty process list.

According to an embodiment, when it is determined at the operation 706 that the application information does not exist in the empty process list, the process management module may execute the empty process of the application at operation 707. Then, at operation 708, the process management module may record (add) the application information (e.g., a name) to the empty process list. At operation 709, the process management module may set a timer for managing the lifecycle of the empty process to ‘0’ and count a time.

According to an embodiment, when it is determined at the operation 706 that the application information exists in the empty process list, the process management module may perform the operation 709. Here, the existence of the application information in the empty process list means that a user input (e.g., a touch-down, a long press, or a scroll) for a corresponding icon occurs, the empty process is executed accordingly, and then a user input for the icon occurs again in a state where the empty process is not terminated.

According to an embodiment, when it is determined at the operation 705 that the flag value indicates any process other than the empty process, the process management module may determine at operation 710 whether the application information (e.g., a name) exists in the empty process list.

According to an embodiment, when it is determined at the operation 710 that the application information exists in the empty process list, the process management module may end a time count, delete the corresponding application information from the empty process list, and execute a component (e.g., an operation of displaying an application screen) of the application at operation 711.

According to an embodiment, when it is determined at the operation 710 that the application information does not exist in the empty process list, the acquired intent may be what is generated by an operation of other application rather than what is generated by a user input (e.g., a touch-up). At operation 712, the process management module may execute a default process (e.g., processes for configuring and displaying a template and launching an application).

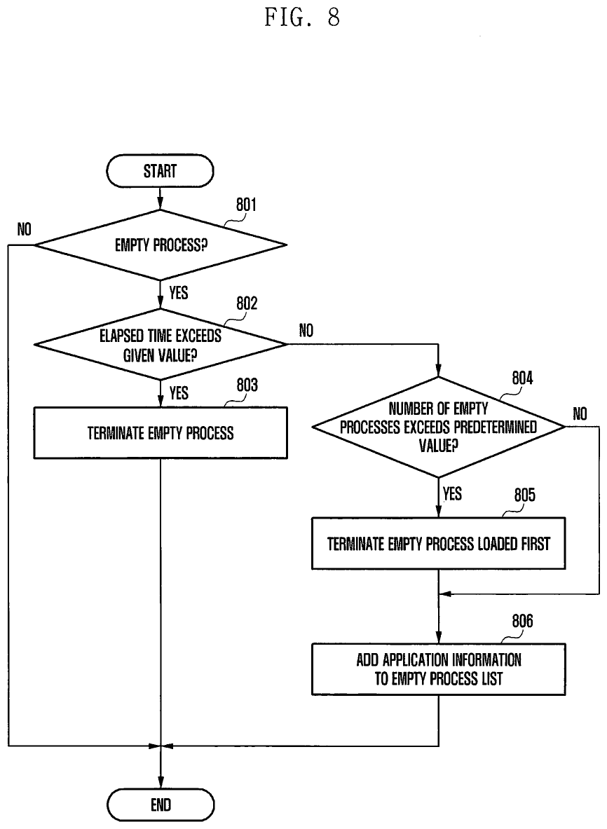

FIG. 8 is a flow diagram illustrating operations of a process management module according to various embodiments.

Referring to FIG. 8, the following operations according to various embodiments may be performed through the electronic device 101, the processor 120, and the program (140 in FIG. 1, 300 in FIG. 3, or 400 in FIG. 4).

According to an embodiment, at operation 801, a process management module (e.g., 330 in FIG. 3 or 430 in FIG. 4) may determine whether a process of an executed application is an empty process. In an embodiment, the empty process may be executed by the occurrence of a touch-down event.

According to an embodiment, in case of the empty process, the process management module may determine at operation 802 whether an elapsed time after the execution of the empty process exceeds a given value (e.g., 1 second).

According to an embodiment, if the given value (e.g., 1 second) is exceeded, the process management module may terminate the empty process at operation 803.

According to an embodiment, if the given value (e.g., 1 second) is not exceeded, the process management module may determine at operation 804 whether the number of applications (e.g., applications executed by the empty process) included in an empty process list exceeds a predetermined value (e.g., two).

According to an embodiment, when it is determined at the operation 804 that the predetermined value is exceeded, the process management module may delete information of an application recorded first in the empty process list at operation 805, and terminate the empty process corresponding to the deleted application information, that is, the empty process loaded first in a memory. Then, at operation 806, the process management module may add information of the executed application to the empty process list.

According to an embodiment, when it is determined at the operation 804 that the predetermined value is not exceeded, the process management module may skip the operation 805 and perform the operation 806.

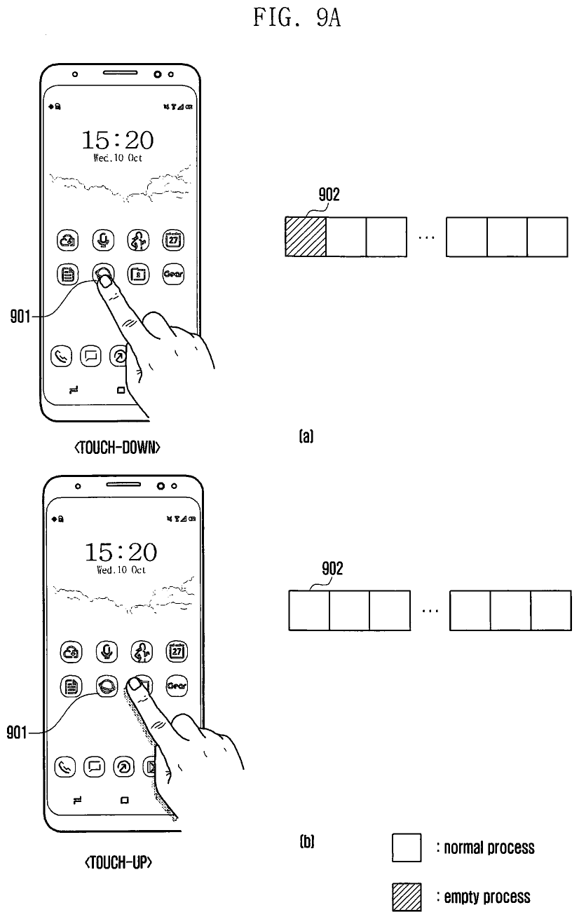

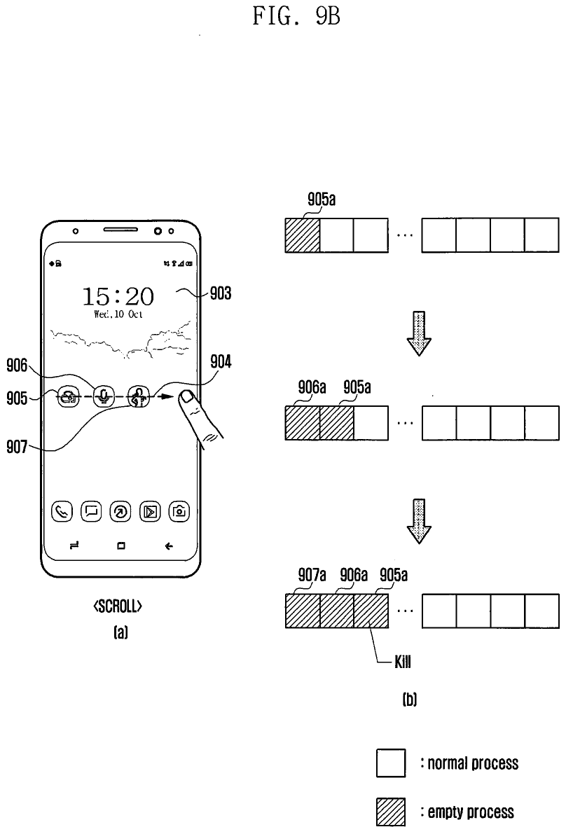

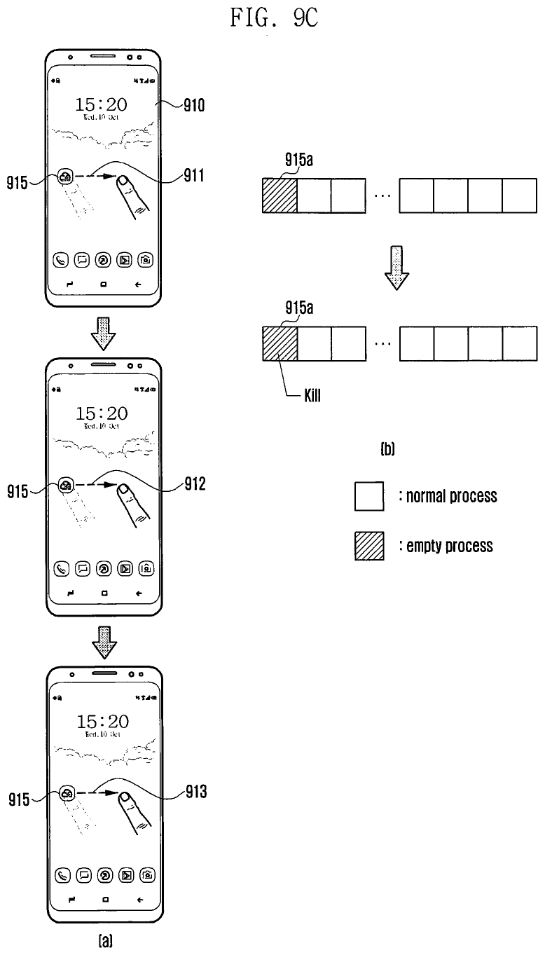

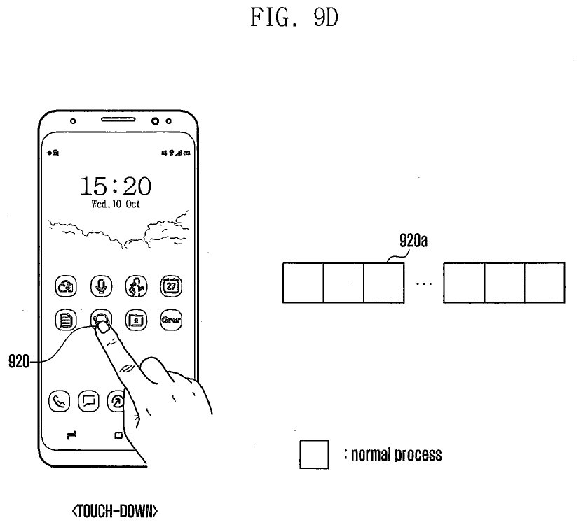

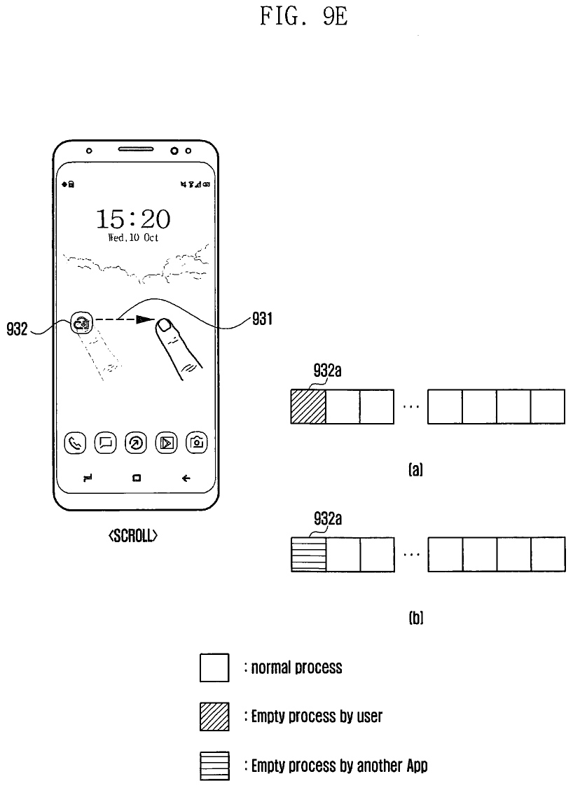

FIGS. 9A to 9E are diagrams illustrating operations of managing a memory in an electronic device according to various embodiments.

Referring to (a) of FIG. 9A, when an icon 901 displayed on the display of the electronic device 101 according to various embodiments is touched (touched down), the processor 120 may call an empty process 902 of an application corresponding to the icon 901 and load the empty process 902 into the volatile memory 132.

Referring to (b) of FIG. 9A, when the icon 901 is touch-released (touched up), the processor 120 according to various embodiments may change the empty process 902 having no component to a normal process (e.g., a foreground process) having a component. For example, the processor 120 may change a flag value of corresponding application information from a value indicating the empty process to a value indicating the foreground process.

A home screen may be composed of, for example, a plurality of pages, each page may contain an icon, and one page may be displayed on the display. A page switch may be made, for example, by a user's scroll on the display.

Referring to (a) of FIG. 9B, a page 903 may be a page arranged first. Therefore, even if a rightward scroll 904 occurs on the page 903, the page switch is not performed. Instead, because it is recognized that icons 905, 906, and 907 are continuously touched, a touch-down event may occur. Therefore, as shown in (b) of FIG. 9B, the processor 120 according to various embodiments may sequentially load empty processes 905a, 906a, and 907a corresponding to the touched icons 905, 906, and 907 into the memory in response to the scroll 904.

According to some embodiments, when a plurality of icons are sequentially long-pressed, corresponding empty processes may be sequentially loaded into the memory.

For an efficient use of a limited memory space, the memory (e.g., the volatile memory 134) according to various embodiments may be managed with a least recently used (LRU) algorithm. The LRU algorism may include an operation of managing the end of a process. According to this management operation, a process having the lowest priority in terms of availability may be deleted first from the memory. For example, a process loaded first into the memory may be deleted first from the memory. In another example, an empty process may have a lower priority than a normal process. Thus, the empty process may be first deleted prior to the normal process. In still another example, when the number of empty processes exceeds a predetermined value (e.g., two), the first loaded process among the empty processes may be deleted.

Referring to (a) of FIG. 9C, a page 910 may be a page arranged first. Therefore, even if rightward scrolls 911, 912, and 913 sequentially occur on the page 910, the page switch is not made. Instead, because it is recognized that one icon 915 is touched several times, a touch-down event may occur. Therefore, as shown in (b) of FIG. 9C, the processor 120 according to various embodiments may load an empty process 915a corresponding to the icon 915 into the memory at the time of a first touch. In addition, whenever a touch occurs on the icon 915, the processor may reset, to ‘0 second’, a counted time for determining whether to end the empty process 915a. When a predetermined time (e.g., 1 second) elapses after the touch, the processor 120 may terminate the empty process 915a.

According to some embodiments, one icon may be long-pressed several times in succession, and a corresponding empty process may be loaded into the memory when the first long press occurs. The processor may count a time during such a periodic long press, and terminate the empty process when a predetermined time (e.g., 1 second) elapses after the first long press.

Referring to FIG. 9D, when a process 920a corresponding to a touched icon 920 has been already loaded in the memory and this is a normal process, the creation of an empty process may be omitted.

Referring to FIG. 9E, an empty process created by a user input (hereinafter referred to as a ‘UserEmpty process’ for convenience of description) may be distinguished from an empty process created by another application (hereinafter referred to as ‘AppEmpty process’ for convenience of description). For example, the UserEmpty process may be different in a flag value from the AppEmpty process.

Referring to (a) of FIG. 9E, when the processor 120 recognizes that an icon 932 displayed on the display is touched down by a scroll 931, a UserEmpty process 932a may be loaded into the memory. The processor 120 according to various embodiments may change the UserEmpty process 932a to an AppEmpty process when receiving a message requesting the execution of the same empty process from another application. In addition, when such a change is made, a time count for determining whether to terminate the empty process may be ended. That is, the AppEmpty process may be managed irrespective of the management of the UserEmpty process, for example, the same as the management of the normal process.

An electronic device according to various embodiments includes a touch-sensitive display; a processor electrically coupled to the display; and a memory electrically coupled to the processor, wherein the memory may store instructions that cause, when executed, the processor to: display an icon on the display, receive a touch-down event for the icon through the display, configure a screen to be displayed on the display, in response to the touch-down event, receive a touch-up event for the icon through the display, and display the configured screen on the display, in response to the touch-up event.

The instructions may cause the processor to: display a screen of an application corresponding to the icon after displaying the configured screen.

The instructions may cause the processor to: load a first process of an application corresponding to the icon into the memory in response to the touch-down event.

The instructions may cause the processor to: delete the first process from the memory when failing to receive the touch-up event for a given time.

The instructions may cause the processor to: load a second process of the application into the memory when receiving the touch-up event within a given time.

The second process may be a process in which an activity is added to the first process.

The activity may include an operation of displaying a screen of the application.

The instructions may cause the processor to: change a state of the first process from a first state to a second state in response to the touch-up event, and when the number of processes set to the first state exceeds a predetermined value, delete a process loaded first into the memory among the processes set to the first state.

The instructions may cause the processor to: change a state of the first process from a first state to a second state in response to the touch-up event. A process set to the second state may have a higher priority than a process set to the first state.

The instructions may cause the processor to: delete the process loaded into the memory, based on the priority.

The instructions may cause the processor to: count a time in response to the touch-down event, delete, from the memory, a process loaded into the memory and corresponding to the icon when the counted time exceeds a predetermined value before the touch-up event is received, and count a time again when a same event as the touch-down event is received before the touch-up event is received.

The instructions may cause the processor to: count a time in response to the touch-down event, delete, from the memory, a process loaded into the memory and corresponding to the icon when the counted time exceeds a predetermined value before the touch-up event is received, and terminate the count when an event occurring by execution of another application, before the touch-up event is received and before the counted time exceeds the predetermined value, is related to the process.

A method for operating an electronic device according to various embodiments may include displaying an icon on a touch-sensitive display; receiving a touch-down event for the icon through the touch-sensitive display; executing a first process corresponding to the icon, in response to the touch-down event; receiving a touch-up event for the icon through the display; and adding an activity of the application to the first process, in response to the touch-up event.

The method may further include deleting the first process when failing to receive the touch-up event for a given time.

The activity may include an operation of displaying a screen of the application on the display.

While the disclosure has been particularly shown and described with reference to exemplary embodiments thereof, it will be understood by those skilled in the art that various changes in form and details may be made therein without departing from the scope of the subject matter as defined by the appended claims.

1. An electronic device comprising:
a touch-sensitive display;
a processor electrically coupled to the display; and
a memory electrically coupled to the processor,
wherein the memory stores instructions that cause, when executed, the processor to:
display an icon on the display,
receive a touch-down event for the icon through the display,
configure a screen to be displayed on the display, in response to the touch-down event,
receive a touch-up event for the icon through the display, and
display the configured screen on the display, in response to the touch-up event.

2. The electronic device of claim 1, wherein the instructions cause the processor to:
display a screen of an application corresponding to the icon after displaying the configured screen.

3. The electronic device of claim 1, wherein the instructions cause the processor to:
load a first process of an application corresponding to the icon into the memory in response to the touch-down event.

4. The electronic device of claim 3, wherein the instructions cause the processor to:
delete the first process from the memory when failing to receive the touch-up event for a given time.

5. The electronic device of claim 3, wherein the instructions cause the processor to:
load a second process of the application into the memory when receiving the touch-up event within a given time.

6. The electronic device of claim 5, wherein the second process is a process in which an activity is added to the first process.

7. The electronic device of claim 6, wherein the activity includes an operation of displaying a screen of the application.

8. The electronic device of claim 3, wherein the instructions cause the processor to:
change a state of the first process from a first state to a second state in response to the touch-up event, and
when the number of processes set to the first state exceeds a predetermined value, delete a process loaded first into the memory among the processes set to the first state.

9. The electronic device of claim 3, wherein the instructions cause the processor to:
change a state of the first process from a first state to a second state in response to the touch-up event, and
wherein a process set to the second state has a higher priority than a process set to the first state.

10. The electronic device of claim 9, wherein the instructions cause the processor to:
delete the process loaded into the memory, based on the priority.

11. The electronic device of claim 1, wherein the instructions cause the processor to:
count a time in response to the touch-down event,
delete, from the memory, a process loaded into the memory and corresponding to the icon when the counted time exceeds a predetermined value before the touch-up event is received, and
count a time again when a same event as the touch-down event is received before the touch-up event is received.

12. The electronic device of claim 1, wherein the instructions cause the processor to:
count a time in response to the touch-down event,
delete, from the memory, a process loaded into the memory and corresponding to the icon when the counted time exceeds a predetermined value before the touch-up event is received, and
terminate the count when an event occurring by execution of another application, before the touch-up event is received and before the counted time exceeds the predetermined value, is related to the process.

13. A method for operating an electronic device, the method comprising:
displaying an icon on a touch-sensitive display;
receiving a touch-down event for the icon through the touch-sensitive display;
executing a first process corresponding to the icon, in response to the touch-down event;
receiving a touch-up event for the icon through the display; and
adding an activity of the application to the first process, in response to the touch-up event.

14. The method of claim 13, further comprising:
deleting the first process when failing to receive the touch-up event for a given time.

15. The method of claim 13, wherein the activity includes an operation of displaying a screen of the application on the display.
